(19) United States
(12) Patent Application Publication
(10) Pub. No.: US 2024/0014422 A1
(43) Pub. Date: Jan. 11, 2024

(54) FUEL CELL SYSTEM AND PURGING CONTROL METHOD THEREOF

(71) Applicant: HYUNDAI MOBIS CO., LTD., Seoul (KR)

(72) Inventors: Jong Bo WON, Yongin-si (KR); Sung Kyung CHOI, Yongin-si (KR); Hye Su LIM, Yongin-si (KR)

(73) Assignee: HYUNDAI MOBIS CO., LTD., Seoul (KR)

(21) Appl. No.: 18/218,217

(22) Filed: Jul. 5, 2023

(30) Foreign Application Priority Data
Jul. 5, 2022 (KR) 10-2022-0082378

(51) Int. Cl. H01M 8/04223; H01M 8/04746; H01M 8/2465; H01M 8/04858

(52) U.S. Cl. CPC H01M 8/04231; H01M 8/04776; H01M 8/2465; H01M 8/0491

(57) ABSTRACT

Described herein is a fuel cell system including a coolant control valve to switch a flowing path of a coolant through a first fluid passage passing through a fuel cell stack and a second fluid passage passing through a cathode oxygen depletion (COD) heater, and a controller to perform a shutdown sequence and control a valve opening amount of the coolant control valve connected to the first fluid passage and the second fluid passage, when shutdown is requested for the fuel cell stack. The coolant control valve is formed by integrating a first valve to switch a flowing path of the coolant flowing into a pump with a second valve to switch a flowing path of a coolant pumped by the pump.

### CROSS-REFERENCE TO RELATED APPLICATION

This application claims the benefit of priority to Korean Patent Application No. 10-2022-0082378, filed in the Korean Intellectual Property Office on Jul. 5, 2022, the entire contents of which are incorporated herein by reference.

### TECHNICAL FIELD

The present disclosure relates to a fuel cell system and a method for controlling shutdown thereof.

### BACKGROUND

A fuel cell system may generate electrical energy using a fuel cell stack. For example, when hydrogen is used as the fuel of a fuel cell stack, hydrogen may be an alternative for a global environment problem. Accordingly, studies and researches for the fuel cell system have been consecutively performed.

The fuel cell system includes a fuel cell stack which generates electrical energy, a fuel supply which supplies fuel (hydrogen) to the fuel cell stack, an air supply which supplies oxygen in the air serving as an oxidant necessary for electrochemical reactions, and a thermal management system (TMS) which removes reaction heat from the fuel cell stack to discharge the reaction heat of the fuel cell stack to the outside of the system, controls an operating temperature of the fuel cell stack, and performs a water managing function.

The TMS is a type of cooling device which circulates antifreeze, which serves as a coolant, to the fuel cell stack to maintain an appropriate temperature (e.g., 60° C. to 70° C.). The TMS may include a TMS line for circulating the coolant, a reservoir to store the coolant, a pump to circulate the coolant, an ion filter to remove ions, which are contained in the coolant, and a radiator to discharge heat from the coolant to the outside. In addition, the TMS may include a heater to heat the coolant, and an air conditioning unit (for example, a warming heater) to heat and warm an inner part of a device (e.g., a vehicle) including a fuel cell system by using the coolant. The TMS may maintain a temperature suitable for a power electronic part of a vehicle as well as a fuel cell stack. The TMS may have power generated from the fuel cell stack and remaining or may have hydrogen and oxygen flowing into the TMS and remaining, in shutdown. When the power or the hydrogen and oxygen remain in the fuel cell stack as described above, carbon at a cathode (an oxygen electrode) of the fuel cell stack may be corroded such that the endurance of the stack may be degraded.

### SUMMARY

The present disclosure has been made to solve the above-mentioned problems occurring in the prior art while advantages achieved by the prior art are maintained intact.

An aspect of the present disclosure is to provide a fuel cell system and a method for controlling the shutdown thereof, capable of ensuring the endurance of a fuel cell stack by removing remaining oxygen, as power generated through the reaction of hydrogen and oxygen remaining in a fuel cell stack by a cathode oxygen depletion heater is consumed in the form of thermal energy when the fuel cell stack is shutdown.

Another aspect of the present disclosure is to provide a fuel cell system and a method for controlling the shutdown thereof, capable of rapidly and easily controlling a flow passage between a fuel cell stack and a COD heater through an integrated coolant control valve, in the shutdown of the fuel cell stack.

The technical problems to be solved by the present disclosure are not limited to the aforementioned problems, and any other technical problems not mentioned herein will be clearly understood from the following description by those skilled in the art to which the present disclosure pertains.

According to an embodiment, a fuel cell system includes a coolant control valve to switch a flowing path of a coolant through a first fluid passage passing through a fuel cell stack and a second fluid passage passing through a cathode oxygen depletion (COD) heater, and a controller to perform a shutdown sequence and control a valve opening amount of the coolant control valve connected to the first fluid passage and the second fluid passage, when shutdown is requested for the fuel cell stack. The coolant control valve is formed by integrating a first valve to switch a flowing path of the coolant flowing into a pump with a second valve to switch a flowing path of a coolant pumped by the pump.

According to an embodiment, the shutdown sequence includes a first operation of setting a revolution per minute (RPM) of the pump to a preset value, a second operation of controlling the valve opening amount of the coolant control valve to close a valve connected to the fuel cell stack and a radiator, a third operation of setting an RPM of a second pump, which supplies the coolant to a cooling fan and a power electronic part, to a preset minimum value, a fourth operation of setting a relay of the COD heater to be turned on, a fifth operation of setting an operating mode of the COD heater to a shutdown mode, a sixth operation of deactivating an under voltage protection logic for the COD heater, and a seventh operation of setting allowable power of the COD heater to a preset value.

According to an embodiment, the coolant control valve includes a first port connected to the second fluid passage passing through the COD heater configured to allow the coolant to flow into the first port, a second port connected to the first fluid passage passing through the fuel cell stack configured to allow the coolant to flow into the second port, a third port to discharge the coolant, which inflows through the first port, through the second fluid passage connected to the pump through a fifth fluid passage configured to serve as a by-pass line of the radiator, a fourth port to discharge the coolant, which inflows through the second port, through the first fluid passage connected to the pump through the fifth fluid passage, and a fifth port to discharge the coolant which inflows through the second port, through a fourth fluid passage passing through the radiator.

According to an embodiment, the coolant control valve is configured to close valves of the second port and the fourth port, which are connected to the first fluid passage, of the coolant control valve, and is configured to open valves of the first port and the third port, which are connected to the second fluid passage, of the coolant control valve, when performing the second operation of the shutdown sequence.

According to an embodiment, the coolant control valve is configured to close a valve of the fifth port, which is connected to the fourth fluid passage, of the coolant control valve to block the coolant from flowing into the radiator, when performing the second operation of the shutdown sequence.

According to an embodiment, the controller iterates the first operation to the seventh operation of the shutdown sequence, until a monitoring voltage of the fuel cell stack is equal to or less than a reference voltage.

According to an embodiment, the shutdown sequence further includes an eighth operation of setting RPMs of the pump, the second pump, and the cooling fan to zero, and a ninth operation of controlling the valve opening amount of the coolant control valve to open values connected to the fuel cell stack and the radiator.

According to an embodiment, the controller performs the eighth operation and the ninth operation of the shutdown sequence, when a monitoring voltage of the fuel cell stack is equal to or less than a reference voltage, during the first operation to the seventh operation of the shutdown sequence.

According to an embodiment, the controller terminates the shutdown of the fuel cell stack, when the shutdown sequence is terminated.

According to an aspect of the present disclosure, a method for controlling shutdown of a fuel cell system, includes performing, by a controller, a shutdown sequence, when shutdown is requested for a fuel cell stack, controlling a valve opening amount of a coolant control valve connected to a first fluid passage passing through the fuel cell stack or a second fluid passage passing through a cathode oxygen depletion (COD) heater, while performing the shutdown sequence, and switching, by the coolant control valve, a flowing path of a coolant through the first fluid passage or the second fluid passage under control of the controller. The coolant control valve is formed by integrating a first valve to switch a flowing path of the coolant flowing into a pump with a second valve to switch a flowing path of a coolant pumped by the pump.

According to an embodiment, the performing of the shutdown sequence includes performing a first operation of setting a revolution per minute (RPM) of the pump to a preset value, performing a second operation of controlling the valve opening amount of the coolant control valve to close a valve connected to the fuel cell stack and a radiator, performing a third operation of setting an RPM of a second pump, which is configured to supply the coolant to a cooling fan and a power electronic part, to a preset minimum value, performing a fourth operation of setting a relay of the COD heater to be turned on, performing a fifth operation of setting an operating mode of the COD heater to a shutdown mode, performing a sixth operation of deactivating an under voltage protection logic for the COD heater, and performing a seventh operation of setting allowable power of the COD heater to a preset value.

According to an embodiment, the coolant control valve includes a first port connected to the second fluid passage passing through the COD heater configured to allow the coolant to flow into the first port, a second port connected to the first fluid passage passing through the fuel cell stack configured to allow the coolant to flow in the second port, a third port to discharge the coolant, which inflows through the first port, through the second fluid passage connected to the pump through a fifth fluid passage configured to serve as a by-pass line of the radiator, a fourth port to discharge the coolant, which inflows through the second port, through the first fluid passage connected to the pump through the fifth fluid passage, and a fifth port to discharge the coolant which inflows through the second port, through a fourth fluid passage passing through the radiator.

According to an embodiment, the performing of the second operation includes closing valves of the second port and the fourth port, which are connected to the first fluid passage, of the coolant control valve, and opening valves of the first port and the third port, which are connected to the second fluid passage, of the coolant control valve.

According to an embodiment, the performing of the second operation includes closing a valve of the fifth port, which is connected to the fourth fluid passage, of the coolant control valve to block the coolant from flowing into the radiator.

According to an embodiment, the performing of the shutdown sequence includes iterating the first operation to the seventh operation of the shutdown sequence, until a monitoring voltage of the fuel cell stack is equal to or less than a reference voltage.

According to an embodiment, the performing of the shutdown sequence includes performing an eighth operation for setting RPMs of the pump, the second pump, and the cooling fan to zero, when the monitoring voltage of the fuel cell stack is equal to or less than the reference voltage, during the first operation to the seventh operation of the shutdown sequence, and performing a ninth operation for controlling the valve opening amount of the coolant control valve to open values connected to the fuel cell stack and the radiator, when the monitoring voltage of the fuel cell stack is equal to or less than the reference voltage, during the first operation to the seventh operation of the shutdown sequence.

According to an embodiment, the method further includes performing the shutdown of the fuel cell stack, when the shutdown sequence is terminated.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a fuel cell system, according to an embodiment of the present disclosure;

FIG. 2 is a view illustrating the control structure of a fuel cell system, according to an embodiment of the present disclosure.

FIG. 3 is a view illustrating the configuration of a coolant control valve, according to an embodiment of the present disclosure;

FIG. 4 is a view illustrating a control block diagram of a fuel cell system, according to an embodiment of the present disclosure;

FIG. 5A is a view illustrating a connection structure of a coolant control valve, according to an embodiment of the present disclosure;

FIG. 5B is a view illustrating a first coolant flow depending on the connection structure of the coolant control valve of FIG. 5A;

FIG. 6A is a view illustrating a connection structure of a coolant control valve, according to an embodiment of the present disclosure;

FIG. 6B is a view illustrating the flow of a first coolant depending on a connection structure of a coolant control valve of FIG. 6A;

FIG. 7 is a view illustrating the flow of an operation for a method for controlling shutdown of a fuel cell system, according to an embodiment of the present disclosure; and

FIG. 8 is a view illustrating the flow of an operation of a shutdown sequence, according to an embodiment of the present disclosure.

### DETAILED DESCRIPTION

Hereinafter, some embodiments of the present disclosure will be described in detail with reference to the accompanying drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In addition, in the following description of components according to an embodiment of the present disclosure, the terms ‘first’, ‘second’, ‘A’, ‘B’, ‘(a)’, and ‘(b)’ may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

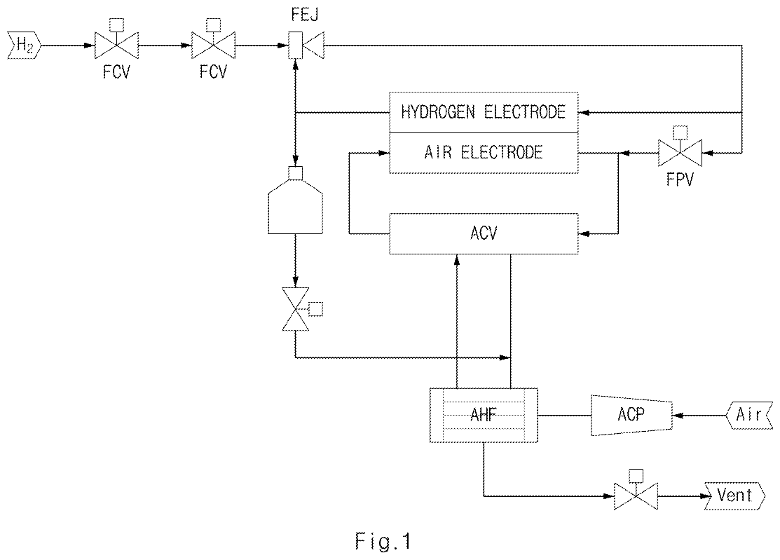

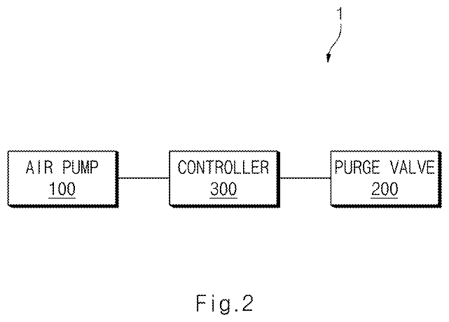

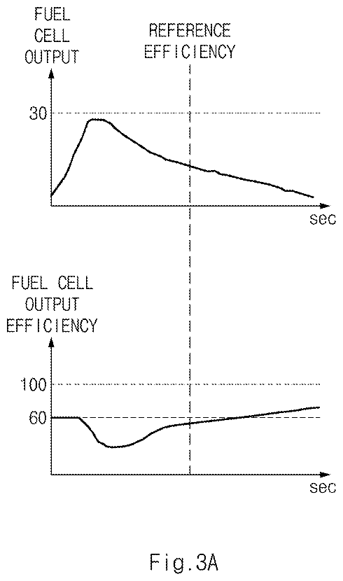

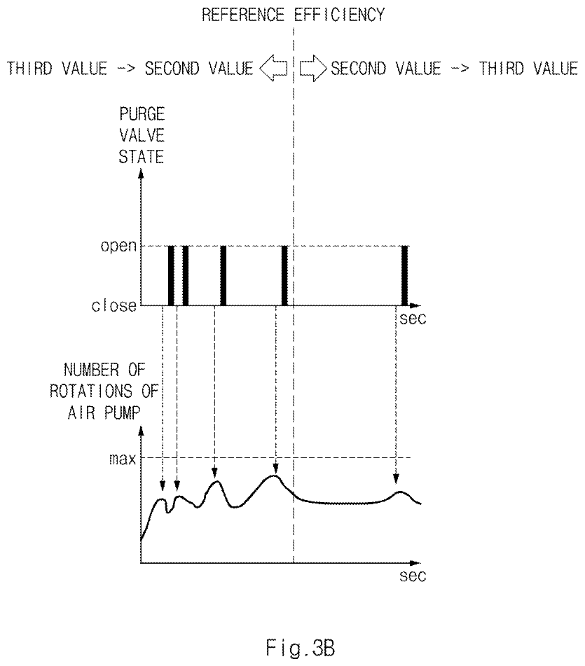

FIG. 1 is a view illustrating a fuel cell system, according to an embodiment of the present disclosure; FIG. 2 is a view illustrating the control structure of a fuel cell system, according to an embodiment of the present disclosure, and FIG. 3 is a view illustrating a coolant control valve according to an embodiment of the present disclosure.

Referring to FIG. 1, a fuel cell system for a vehicle may include a first cooling line allowing the circulation of a first coolant passing through the fuel cell stack 10 of the vehicle and a second cooling line 160 allowing the circulation of a second coolant passing through a power electronic part 200. According to an embodiment, the fuel cell system may further include a heat exchanger 300 to mutually exchange heat between the first coolant and the second coolant.

The fuel cell system may include a plurality of fluid passages (for example, a first fluid passage 110 to a fifth fluid passage 150) forming the first cooling line. The first coolant may be cooled down and heated while being circulated through the first fluid passage 110 to the fifth fluid passage 150.

A fuel cell stack 10, a cathode oxygen depletion heater 20, a first pump 30, a coolant ion filter (CIF) 40, and a first radiator 50 may be configured to be provided on the first fluid passage 110 to the fifth fluid passage 150 for circulating the first coolant.

The fuel cell stack 10 (or which may be referred to as a ‘fuel cell’) has a structure capable of producing electricity through a redox reaction between a fuel (e.g., hydrogen) and an oxidizing agent (e.g., air). For example, the fuel cell stack 10 may include a membrane electrode assembly (MEA) in which catalyst electrode layers making electrochemical reactions are attached to opposite sides of an electrolyte membrane for moving hydrogen ions, a gas diffusion layer (GDL), which uniformly distributes reaction gases and transfers generated electrical energy, a gasket and fastening mechanism to maintain airtightness and proper fastening pressure of the reaction gases and a first coolant, and a bipolar plate to move the reaction gases and the first coolant.

In the fuel cell stack 10, the hydrogen serving as fuel and the air (oxygen) serving as the oxidizing agent may be supplied to the anode and the cathode of the MEA through a fluid passage of the bipolar plate. For example, the hydrogen may be supplied to the anode and the air may be supplied to the cathode. The hydrogen, which is supplied to the anode, is decomposed into a proton and an electron through catalysts provided at opposite sides of an electrolyte film. Among them, only a hydrogen ion selectively passes through the electrolyte film, which is a cation exchange membrane, and is transmitted to the cathode while the electron is transmitted to the cathode through a gas diffusion layer and the bipolar plate. In the cathode, the hydrogen ions supplied through the electrolyte film and the electrons received through the bipolar plate meet oxygen of the air supplied to the cathode through an air supply device, thereby generating water. In this case, the electrons may flow through an external conductive line due to the transfer of the hydrogen ions, and the flow of the electrons may generate a current.

When the electrical conductivity of the first coolant is increased due to the corrosion or the exudation of the system, electricity flows to the first coolant, such that the fuel cell stack 10 may be shorted or a current may flow toward the first coolant. Accordingly, the first coolant should be maintained with a lower electrical conductivity. To this end, the ion filter 40 may filter an ion of the first coolant. The ion filter 40 may be set to remove an ion from the first coolant to maintain the electrical conductivity of the first coolant to be at a specific level or less.

The first radiator 50 may be set to cool the first coolant moving along the plurality of fluid passages, and the cooling fan 60 may be set to blow external air to the first radiator 50. The first radiator 50 may be formed in various structures to cool the first coolant, and the present disclosure is not limited by the type and the structure of the first radiator 50. The first radiator 50 may be connected to the reservoir 52 to store the first coolant.

The fluid passage to move the first coolant may include the first fluid passage 110 to pass through the fuel cell stack 10, the second fluid passage 120 to pass through the COD heater 20, and the third fluid passage 130 to pass through the ion filter 40. Alternatively, the fluid passage to move the first coolant may further include the fourth fluid passage 140 to pass through the first radiator 50 such that the first coolant heated by the fuel cell stack is cooled, and the fifth fluid passage 150 to pass through the first radiator 50 by by-passing the first radiator 50.

In addition, the fuel cell system may further include a coolant control valve 70 to switch a moving path of the first coolant through the first to fifth fluid passages 110 to 150. For example, the coolant control valve 70 may be configured in the form of an integrated coolant temperature control valve (ICTV) in which a first valve (for example, a coolant temperature control valve (CTV) to switch the flowing path of the first coolant flowing into the first pump 30 is integrated with a second valve (for example, a coolant bypass valve (CBV) to switch the flowing path of the first coolant pumped by the first pump 30. In this case, the first pump 30 may be a coolant supply pump (CSP).

The coolant control valve 70 may include a plurality of ports connected to the first to fifth fluid passages 110 to 150, and the valve opening state of each valve may be controlled by the controller 400.

Referring to FIG. 2, the controller 400 may be connected to components of the fuel cell system to control the overall functions of the fuel cell system. The controller 400 may be a hardware device, such as a processor or a central processing unit (CPU), or a program implemented by the processor. For example, the controller 400 may be an upper controller of the fuel cell system.

The controller 400 may transmit or receive a signal to or from driving units of the fuel cell stack 10, the COD heater 20, the first pump 30, the ion filter 40, the first radiator 50, and the cooling fan 60, may determine a control amount of each driving unit, and may manage the operating state of each driving unit.

The controller 400 may transmit or receive a signal to or from driving units of the fuel cell stack 10, the COD heater 20, the first pump 30, the ion filter 40, the first radiator 50, and the cooling fan 60, may determine a control amount of each driving unit, and may manage the operating state of each driving unit. The controller 400 may determine target cooling performance of the fuel cell stack 10 for thermal management control when the fuel cell system is turned on, and may determine whether the target cooling performance of the fuel cell stack 10 is satisfied while driving each driving unit during the thermal management control operation.

When the target cooling performance of the fuel cell stack 10 is determined to perform the thermal management control operation, the controller 400 may determine the revolutions per minute (RPM) of the first pump 30 and the RPM of the cooling fan 60, based on the determined target cooling performance of the fuel cell stack 10.

In addition, the controller 400 may determine a valve opening amount of each port provided in the coolant control valve 70, based on the temperature of the first coolant. The controller 400 may determine the flow rate of the first coolant, based on the RPM of the cooling fan 60, the temperature of the first coolant in an inlet and an outlet of the fuel cell stack 10, and the temperature of the first coolant in the outlet of the first radiator 50, and may determine the opening degree of the coolant control valve 70 based on the flow rate of the first coolant determined. In this case, the controller 400 may determine the flow rate of the first coolant flowing along each fluid passage, based on the temperature of the first coolant measured by the temperature sensor (not illustrated) provided on the fourth to fifth fluid passages 110 to 150 illustrated in FIG. 1. For example, the temperature sensor may measure the temperature of the first coolant in the inlet and the outlet of the fuel cell stack 10, the temperature of the first coolant in the outlet of the first radiator 50, and the temperature of the first coolant in the COD heater 20.

The controller 400 may control an inflowing flow rate of the first coolant to be lower than a preset flow rate, when the measured temperature of the first coolant circulated along a specific fluid passage is lower than a preset target temperature. As described above, when the measured temperature of the first coolant is lower, the inflowing flow rate of the first coolant flowing into the fuel cell stack 10 is controlled to be lower, thereby minimizing the thermal impact and the degradation in performance due to the difference between the temperature of the first coolant staged inside the fuel cell stack 10 and the temperature of the first coolant flowing into the fuel cell stack 10.

Referring to FIG. 3, the coolant control valve 70 may be a 5-way valve. For example, the coolant control valve 70 may include the first port 71 and the second port 72 which allow the first coolant to flow in, and may include the third port 73, the fourth port 74, and the fifth port 75, which are to discharge the first flowing in through the first port 71 or the second port 72. In this case, the first port 71 and the third port 73 may be adjusted to have an opening degree of a valve ranging from a first value θ1 to a second value θ2. Meanwhile, the second port 72, the fourth port 74, and the fifth port 75 may be adjusted to have the opening degree of the valve in the range of the second value θ2 to the third value θ3.

The first port 71 may be connected to the second fluid passage 120 to pass through the COD heater 20 and the third fluid passage 130 to pass through the ion filter 40, such that the first coolant flows into the first port 71 after passing through the second fluid passage 120 and the third fluid passage 130 when the first port 71 is open.

The second port 72 may be connected to the first fluid passage 110 to pass through the fuel cell stack 10 and the third fluid passage 130 to pass through the ion filter 40, such that the first coolant flows in the second port 72 after passing through the first fluid passage 110 and the third fluid passage 130 when the second port 72 is open. In this case, the first coolant passing through the ion filter 40 may flow into the first port 71 or the second port 72 depending on the opening/closing state of the first port 71 and the second port 72.

The third port 73 and the fourth port 74 are connected to the fifth fluid passage 150 to allow the first coolant to flow into an inlet of the first pump 30 without passing through the first radiator 50. For example, the third port 73 may be open together with the first port 71 when the first port 71 is opened, to discharge the first coolant, which flows in through the first port 71, to the fifth fluid passage 150. The fourth port 74 may be opened when the second port 72 is opened, to discharge a portion or an entire portion of the first coolant flowing in through the second port 72 to the fifth fluid passage 150.

The fifth port 75 may be connected to the fourth fluid passage 140 to pass through the first radiator 50 to discharge the first coolant to the fourth fluid passage 140 when the fifth port 75 is opened. The fifth port 75 may be opened when the second port 72 is opened, to discharge a portion or an entire portion of the first coolant, which flows in through the second port 72, to the fourth fluid passage 140.

The first coolant discharged through the fifth port 75 may be cooled through the first radiator 50 while flowing along the fourth fluid passage 140, and may flow into the first pump 30.

The first to fifth ports 71 to 75 of the coolant control valve 70 may be controlled to be opened or closed by the controller 400. In other words, the controller 400 may determine the flowing path of the first coolant among the first to fifth fluid passages 110 to 150 illustrated in FIG. 1, and may control the open or closed state of a valve of each port provided in the coolant control valve 70 along the flowing path of the first coolant determined.

The coolant control valve 70 may switch the flowing path of the first coolant circulating the fuel cell system by opening valves of some ports of the first to fifth ports 71 to 75 in response to the control signal from the controller 400. In this case, the first coolant may be cooled or heated while circulating along some fluid passages of the first fluid passage 110, the second fluid passage 120, the third fluid passage 130, the fourth fluid passage 140, and the fifth fluid passage 150.

Meanwhile, the second cooling line 160 may be formed to pass through the power electronic part 200 of the vehicle, and the second coolant may be circulated along the second cooling line 160. In this case, the power electronic part 200 of the vehicle may be understood as a part used as an energy source of the power for the vehicle, and the present disclosure is not limited by the type and the number of the power electronic parts 200.

For example, the power electronic part 200 may include at least one of a bi-directional high voltage DC-DC converter 210 interposed between the fuel cell stack 10 and a high-voltage battery (not illustrated) of the vehicle, a blower pump control unit 220 to control a blower (not illustrated) to supply external air for driving the fuel cell stack 10, a low-voltage DC-DC converter 230 to convert a DC high voltage received from the high-voltage battery into a DC low voltage, an air compressor (ACP) 240 to compress air supplied to the fuel cell stack 10, and an air cooler 250. Although not illustrated in FIG. 1, the power electronic part 200 may further include a DC-DC buck/boost converter.

A second pump 205 may be disposed on the second cooling line 160 to force the second coolant to flow. The second pump 205 may include a pumping device to pump the second coolant, but the present disclosure is not limited to the type and the characteristic of the second pump 205.

The second radiator 55 may be disposed on the second cooling line 160 to cool the second coolant. The second radiator 55 may be formed in various structures to cool the second coolant, and the present disclosure is not limited by the type and the structure of the second radiator 55. The second radiator 55 may be connected to a reservoir 57 to store the second coolant.

According to an embodiment, the first radiator 50 and the second radiator 55 may be configured to simultaneously perform cooling by one cooling fan 60 as illustrated in FIG. 1. For example, the first radiator 50 and the second radiator 55 may be disposed in parallel to each other, and the cooling fan 60 may be set to blow external air to the first radiator 50 and the second radiator 55. As the first radiator 50 and the second radiator 55 are simultaneously cooled by one cooling fan 60, the structure of the fuel cell system may be simplified, or the degree of freedom in design, the utilization of a space may be improved, and power consumption to cool the first radiator 50 and the second radiator 55 may be minimized. Alternatively, the first cooling fan to cool the first radiator 50 and the second cooling fan to cool the second radiator 55 may be separately disposed. In this case, when the fuel cell system controls the RPM of the first cooling fan, a parameter related to a thermal load of the power electronic part 200 may be excluded.

The heat exchanger 300 may be set to mutually exchange heat between the first coolant and the second coolant. When the heat exchanger 300 is provided, the first cooling line including the first to fifth fluid passages 110 to 150, and the second cooling line 160 may form a thermal management system (TMS) line for allowing the first coolant and the second coolant to flow while mutually exchanging the heat between the first coolant and the second coolant. In this case, the first coolant or the second coolant may be used as a cooling medium or a heat medium on the TMS line. For example, since the temperature of the second coolant for cooling the power electronic part 200 is formed to be lower than the temperature of the first coolant for cooling the fuel cell stack 10, the fuel cell system may lower the temperature of the first coolant without increasing the capacity of the first radiator 50 and the cooling fan 60, the cooling efficiency of the fuel cell stack 10 may be improved, and the stability and the reliability may be improved, as the heat is mutually exchanged between the first coolant and the second coolant.

According to an embodiment, the heat exchanger 300 may be connected to the first cooling line between the outlet of the first radiator 50 and the fuel cell stack 10, and the second cooling line 160 may connect the outlet of the second radiator 55 to the power electronic part 200 such that the second cooling line 160 passes through the heat exchanger 300. For example, the first coolant may flow along the heat exchanger 300 connected to the first cooling line, and the second cooling line 160 may pass through an inner part of the heat exchanger 300 to be exposed to the first coolant (for example, for the first coolant to flow along the circumference of the second cooling line 160.

As described above, the fuel cell system may lower the temperature of the first coolant introduced into the fuel cell stack 10 as the heat is mutually exchanged between the first coolant and the second coolant. The first temperature of the first coolant passing through the first radiator 50 may be formed to be higher than the second temperature of the second coolant passing through the second radiator 55, and the third temperature of the first coolant passing through the heat exchanger 300 may be formed to be lower than the first temperature. For example, the first temperature of the first coolant may be formed to be higher than the second temperature of the second coolant by 10° C., and the third temperature of the first coolant (heat-exchanged with the second coolant) passing through the heat exchanger 300 may be formed to be lower than the first temperature by 1° C. Although the heat exchanger 300 is disposed separately from the first radiator 50, the heat exchanger 300 may be directly connected to the first radiator 50 according to an embodiment.

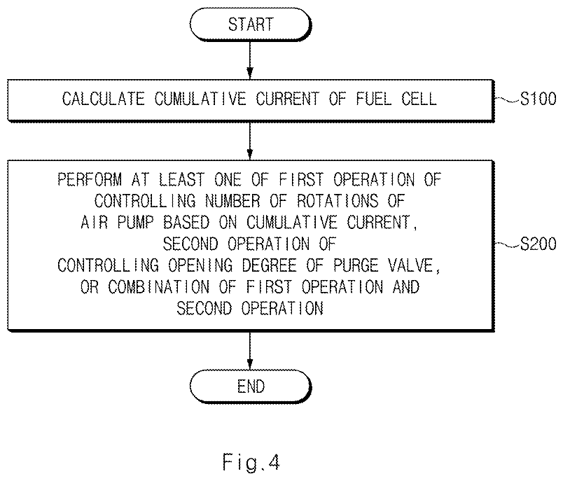

FIG. 4 is a control block diagram for controlling a fuel cell system, according to an embodiment of the present disclosure. The control block diagram illustrated in FIG. 4 illustrates a control structure to control the shutdown of the fuel cell system.

Referring to FIG. 4, the controller 400 stops shut down the fuel cell system by executing a shutdown sequence defined in advance, when the shutdown request is made during the operation for the fuel cell stack 10. In this case, the controller 400 may determine whether to execute a cold shutdown operation or a normal shutdown operation depending on the external temperature.

Accordingly, the fuel cell system may further include an external temperature sensor 410 to measure the external temperature of the vehicle. The controller 400 receives information on external temperature measured by the external temperature sensor 410, when the shutdown request is made during the driving of the fuel cell stack 10. In this case, the controller 400 may execute a first shutdown sequence for cold shut, when the temperature of the external air received from the external temperature sensor 410 is equal to or less a specific temperature, and, otherwise, may execute a second shutdown sequence for normal shutdown. In this case, the first shutdown sequence and the second shutdown sequence may include a shutdown sequence executed in common. Meanwhile, the first shutdown sequence may further include an additional operation separated from the second shutdown sequence. However, according to an embodiment of the present disclosure, the details of the operation separately performed in the first shutdown sequence and the second shutdown sequence may be omitted.

The controller 400 may control the COD heater 20, the first pump (CSP) 30 and the second pump (CPP) 205, the cooling fan (C/FAN) 60, and the coolant control valve (ICTV) 70.

First, the controller 400 may set the RPM of the first pump 30 to the first set value w1, as the first operation of the shutdown sequence.

In addition, the controller 400 may set a valve opening amount of each port to a specific angle through the coolant control valve (ICTV) 70, as the second operation of the shutdown sequence. In this case, the controller 400 may block the first coolant from flowing into the fuel cell stack 10 during the operation of the shutdown sequence and may control the valve opening amount of the coolant control valve (ICTV) 70 such that the first coolant flowing through the first radiator 50 is bypassed to prevent the first coolant from being cooled. In this case, the controller 400 may allow the first coolant to flow into the COD heater 20 connected to the inlet and the outlet of the fuel cell stack 10.

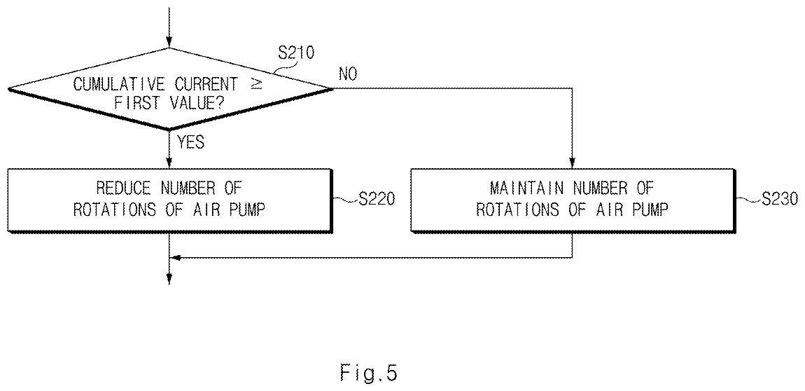

Accordingly, the connection structure of the coolant control valve 70 and the flow of the coolant based on the shutdown sequence will be described with reference to FIGS. 5A and 5B.

FIG. 5A is a view illustrating the connection structure of the coolant control valve in shutdown according to an embodiment of the present disclosure, and FIG. 5B is a view illustrating the flow of the first coolant based on the connection structure of the coolant control valve of FIG. 5A.

Referring to FIG. 5A, the controller 400 may close the second port 72 and the fourth port 74 of the coolant control valve 70 connected to the first fluid passage 110 passing through the fuel cell stack 10 to block the first coolant from being supplied to the fuel cell stack 10, and may op en the valve of the first port 71 and the third port 73 of the coolant control valve 70 connected to the second fluid passage to supply the first coolant to the COD heater 20. In addition, the controller 400 may close the valve of the fifth port 75 of the coolant control valve 70 connected to the fourth fluid passage 140 for passing through the first radiator 50 to bypass the first coolant flowing into the first radiator 50, and may open the valve of the third port 73 connected to the fifth fluid passage which is the bypass line of the first radiator 50.

As described above, the coolant control valve (ICTV) 70 closes the second port 72, the fourth port 74, and the fifth port 75 to prevent the first coolant from flowing into the fuel cell stack 10 and the first radiator 50, and opens the first port 71 and the third port 73 to prevent the first coolant from flowing into the COD heater 20 and the ion filter 40. Accordingly, a heating loop is formed such that the first coolant circulates along the second fluid passage 120 and the fifth fluid passage 150.

In this case, the flow of the first coolant based on the control of the coolant control valve 70 is illustrated in FIG. 5B As illustrated in FIG. 5B, in shutdown, the first coolant may be heated by the COD heater 20 while circulating the heating loop along the second fluid passage 120 and the fifth fluid passage 150. In addition, as the first coolant is circulated along the third fluid passage 130 while circulating the second fluid passage 120 and the fifth fluid passage 150, the electrical conductivity of the first coolant may be maintained to be at a specific level through filtering (removing an ion included in a coolant) by the ion filter 40 provided on the third fluid passage 130.

In addition, the controller 400 may be set the RPM of the cooling fan (C/FAN) 60 and the second pump CPP to the minimum set value MIN, as a third operation of the shutdown sequence.

Alternatively, when the first to third operations of the shutdown sequence have been finished, the controller 400 controls the relay of the COD heater (COD HTR) 20 to be turned on, as the fourth operation, and then sets the operating mode of the COD heater 20 as a shutdown mode, as the fifth operation. In this case, the relay of the COD heater 20 may be disposed on a line connecting the fuel cell stack 10 to the COD heater 20. When the relay of the COD heater 20 is controlled to be turned on, the fuel cell stack 10 may be connected to the COD heater 20.

In shutdown, when power generated from the fuel cell stack 10 remains in the fuel cell stack 10, the safety of the fuel cell stack 10 may be degraded, and the endurance of the fuel cell stack 10 may be degraded. Accordingly, in shutdown, the COD heater 20 is connected to the inlet and the outlet of the fuel cell stack 10, and the power remaining in the fuel cell stack 10 is discharged in the form of thermal energy such that the power remaining in the fuel cell stack 10 may be totally consumed. Accordingly, the endurance of the fuel cell stack 10 may be prevented from being degraded.

When the voltage of the fuel cell stack 10 is dropped down to the minimum operating voltage of the COD heater 20, the operating time of the COD heater 20 is increased, so the endurance of the COD heater 20 is degraded. To prevent the endurance of the COD heater 20 from being degraded, the voltage protecting logic 420 is activated in the operation of the COD heater 20. For example, the fuel cell system may stop the operation of the COD heater 20 when the voltage of the fuel cell stack 10 is dropped down to the minimum operating voltage of the COD heater 20, by activating a under voltage protection logic, thereby preventing the endurance of the COD heater 20 from being degraded. However, in shutdown, the power generation of the fuel cell stack 10 is stopped. Accordingly, the voltage of the fuel cell stack 10 is gradually dropped. In this case, even if the voltage of the fuel cell stack 10 is dropped down to the minimum operating voltage of the COD heater 20, the operation of the COD heater 20 should not be stopped to remove hydrogen, oxygen, or power remaining in the fuel cell stack 10. Accordingly, the controller 400 deactivates the under voltage protection logic such that the COD heater 20 is not stopped during the operation of the shutdown mode, as a sixth operation.

In this case, the controller 400 sets the allowable power of the COD heater 20 to a first power value P1, as a seventh operation. In this case, the controller 400 may set the allow power of the COD heater 20 to be a higher value, to consume the hydrogen, the oxygen, and the power remaining in the fuel cell stack 10.

The controller 400 monitors the voltage of the fuel cell stack 10 after performing the first operation to the seventh operation of the shutdown sequence. In this case, the controller 400 iterates the first operation to the seventh operation, when the monitoring voltage (V_{SVM}) of the fuel cell stack 10 exceeds a preset reference voltage V1.

Meanwhile, the controller 400 may determine that the hydrogen, the oxygen, or the power remaining in the fuel cell stack 10 more or less, when the monitoring voltage VSVM of the fuel cell stack 10 is dropped to a reference voltage V1 or less. Accordingly, the controller 400 sets the RPM of the cooling fan (C/FAN) 60, the first pump 30, and the second p ump 205 to ‘0’, as the eighth operation, and opens all valves of ports connected to the fuel cell stack 10 and the first radiator 50, as the ninth operation.

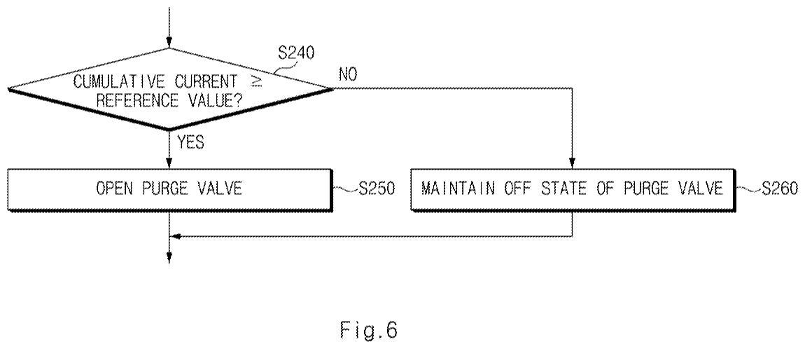

The coolant control valve 70 opens all valves of the ports connected to the fuel cell stack 10 and the first radiator 50. Accordingly, the connection structure of the coolant control valve 70 and the flow of the coolant based on the shutdown sequence will be described with reference to FIGS. 6A and 6B.

Referring to FIG. 6A, the coolant control valve 70 opens the valves of ports, that is, the second port 72 and the fifth port 75, connected to the fuel cell stack 10 and the first radiator 50. In this case, the controller 400 may open the valve of the fourth port 74. In this case, a portion of the first coolant may pass through the first radiator 50 along the fourth fluid passage 140, and a remaining portion of the first coolant may flow along the fifth fluid passage 150.

Meanwhile, the coolant control valve 70 may close the valves of the first port 71 and the third port 73 connected to the second fluid passage 120 to prevent the first coolant from flowing into the COD heater 20. In this case, as illustrated in FIG. 6B, a cooling loop may be formed to allow the first coolant to circulate along the first fluid passage 110, the third fluid passage 130, the fourth fluid passage 140, and the fifth fluid passage 150.

The controller 400 may turn off the fuel cell system, when all operations defined in the shutdown sequence are performed.

Hereinafter, the flow of the operations for thermal management control of the fuel cell system having the above structure according to the present disclosure will be described in more detail

FIG. 7 is a view illustrating the flow of an operation for a method for controlling shutdown of a fuel cell system, according to an embodiment of the present disclosure, and FIG. 8 is a view illustrating the flow of an operation of a shutdown sequence, according to an embodiment of the present disclosure.

First, referring to FIG. 7, the fuel cell system determines the temperature of external air, which is received from the external temperature sensor 410, when shutdown is requested during the operation of the fuel cell stack 10 (S110 and S120). In this case, when the determined temperature of the external air is equal to or less than a specific temperature T (S130), the fuel cell system determines a cold shutdown condition as being satisfied to perform cold shutdown (S140). Otherwise, the fuel cell system performs normal shutdown (S150).

In this case, the fuel cell system may perform the shutdown sequence of FIG. 8 in cold shutdown or normal shutdown.

Referring to FIG. 8, the fuel cell system sets the RPM of the first pump (CSP) 30 to a first set value (w1) (S210), blocks the first coolant from flowing into the fuel cell stack 10 during the shutdown sequence, and controls the valve opening amount of the coolant control valve (ICTV) such that the first coolant flowing into the first radiator 50 is by-passed to prevent the first coolant from being cooled (S220).

Alternatively, the fuel cell system may set the RPM of the cooling fan (C/FAN) 60 and the RPM of the second pump (CPP) to the minimum set value (MIN) (S230) and may control the relay of the COD heater (COD HTR) 20 to be turned on (S240). In this case, the relay of the COD heater 20 may be disposed on a line connecting the fuel cell stack 10 to the COD heater 20. When the relay of the COD heater 20 is controlled to be turned on, the fuel cell stack 10 may be connected to the COD heater 20. Accordingly, in shutdown, the COD heater 20 is connected to the inlet and the outlet of the fuel cell stack 10, and the power remaining in the fuel cell stack 10 is discharged in the form of thermal energy such that the power remaining in the fuel cell stack 10 may be totally consumed. Accordingly, the endurance of the fuel cell stack 10 may be prevented from being degraded.

Thereafter, the fuel cell system sets the operating mode of the COD heater 20 to the shutdown mode (S250). In this case, the fuel cell system deactivates the under voltage protection logic such that the COD heater 20 is not stopped during the operation of the shutdown mode (S260), to remove hydrogen, and oxygen, or power remaining in the fuel cell stack 10, even if the voltage of the fuel cell stack 10 is dropped to the lowest operating voltage of the COD heater 20, as the power generation by the fuel cell stack 10 is stopped (S260), and sets the allowable power of the COD heater 20 to the first power value P1 (S270). In this case, the fuel cell system may set the allowable power of the COD heater 20 to be a higher value, to consume the hydrogen and the oxygen, or the power remaining in the fuel cell stack 10.

The fuel cell system monitors the voltage of the fuel cell stack 10 after performing the operations of S210 to S270, and may iterate the operations of S210 to S270 when the monitoring voltage (V_{SVM}) of the fuel cell stack 10 exceeds a preset reference voltage V1 (S280), the operations of S10 to S270 are iterated.

Meanwhile, in S280, the fuel cell system may determine that the hydrogen AND the oxygen, or the power remaining in the fuel cell stack 10 is removed more or less, when the monitoring voltage V_{SVM} of the fuel cell stack 10 is dropped to a reference voltage V1 or less to set the RPM of the cooling fan (C/FAN) 60, the first pump CSP, sets the RPM of the cooling fan (C/FAN) 60, the first pump (CSP) 30, and the second pump (CPP) 205 to ‘0’ (S290), and open all valves of ports connected to the fuel cell stack 10 and the first radiator 50 through the coolant control valve 70 (S300).

The fuel cell system is turned off, when all operations defined in the shutdown sequence and illustrated in FIG. 8 are performed (S160).

According to an embodiment of the present disclosure, in the shutdown of the fuel cell stack, as the power generated through the reaction between the hydrogen and the oxygen remaining in the fuel cell stack is consumed in the form of thermal energy by the COD heater to remove all remaining oxygen, thereby ensuring the endurance of the fuel cell stack.

In addition, according to an embodiment of the present disclosure, in the shutdown of the fuel cell stack, the fluid passage between the fuel cell stack and the COD heater may be rapidly and easily controlled through the integrated coolant control valve.

The above description is merely an example of the technical idea of the present disclosure, and various modifications and modifications may be made by one skilled in the art without departing from the essential characteristic of the invention.

Accordingly, embodiments of the present disclosure are intended not to limit but to explain the technical idea of the present disclosure, and the scope and spirit of the invention is not limited by the above embodiments. The scope of protection of the present disclosure should be construed by the attached claims, and all equivalents thereof should be construed as being included within the scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A fuel cell system comprising:
a coolant control valve configured to switch a flowing path of a coolant through a first fluid passage passing through a fuel cell stack and a second fluid passage passing through a cathode oxygen depletion (COD) heater; and
a controller configured to perform a shutdown sequence and control a valve opening amount of the coolant control valve connected to the first fluid passage and the second fluid passage, when shutdown is requested for the fuel cell stack,
wherein the coolant control valve is formed by integrating a first valve to switch a flowing path of the coolant flowing into a pump with a second valve to switch a flowing path of a coolant pumped by the pump.

2. The fuel cell system of claim 1, wherein the shutdown sequence includes:
a first operation of setting a revolution per minute (RPM) of the pump to a preset value;
a second operation of controlling the valve opening amount of the coolant control valve to close a valve connected to the fuel cell stack and a radiator;
a third operation of setting an RPM of a second pump, which supplies the coolant to a cooling fan and a power electronic part, to a preset minimum value;
a fourth operation of setting a relay of the COD heater to be turned on;
a fifth operation of setting an operating mode of the COD heater to a shutdown mode;
a sixth operation of deactivating an under voltage protection logic for the COD heater and
a seventh operation of setting allowable power of the COD heater to a preset value.

3. The fuel cell system of claim 2, wherein the coolant control valve includes:
a first port connected to the second fluid passage passing through the COD heater configured to allow the coolant to flow into the first port;
a second port connected to the first fluid passage passing through the fuel cell stack configured to allow the coolant to flow into the second port;
a third port configured to discharge the coolant, which inflows through the first port, through the second fluid passage connected to the pump through a fifth fluid passage configured to serve as a by-pass line of the radiator;
a fourth port configured to discharge the coolant, which inflows through the second port, through the first fluid passage connected to the pump through the fifth fluid passage; and
a fifth port configured to discharge the coolant which inflows through the second port, through a fourth fluid passage passing through the radiator.

4. The fuel cell system of claim 3, wherein the coolant control valve is configured to close valves of the second port and the fourth port, which are connected to the first fluid passage, of the coolant control valve, and and configured to open valves of the first port and the third port, which are connected to the second fluid passage, of the coolant control valve, when performing the second operation of the shutdown sequence.

5. The fuel cell system of claim 3, wherein the coolant control valve is configured to close a valve of the fifth port, which is connected to the fourth fluid passage, of the coolant control valve to block the coolant from flowing into the radiator, when performing the second operation of the shutdown sequence.

6. The fuel cell system of claim 2, wherein the controller is configured to:
iterate the first operation to the seventh operation of the shutdown sequence, until a monitoring voltage of the fuel cell stack is equal to or less than a reference voltage.

7. The fuel cell system of claim 6, wherein the shutdown sequence further includes:
an eighth operation of setting RPMs of the pump, the second pump, and the cooling fan to zero, and a ninth operation of controlling the valve opening amount of the coolant control valve to open values connected to the fuel cell stack and the radiator.

8. The fuel cell system of claim 7, wherein the controller is configured to:
perform the eighth operation and the ninth operation of the shutdown sequence, when a monitoring voltage of the fuel cell stack is equal to or less than a reference voltage, during the first operation to the seventh operation of the shutdown sequence.

9. The fuel cell system of claim 1, wherein the controller is configured to:
terminate the shutdown of the fuel cell stack, when the shutdown sequence is terminated.

10. A method for controlling shutdown of a fuel cell system, the method comprising:
performing, by a controller, a shutdown sequence, when shutdown is requested for a fuel cell stack;
controlling a valve opening amount of a coolant control valve connected to a first fluid passage passing through the fuel cell stack or a second fluid passage passing through a cathode oxygen depletion (COD) heater, while performing the shutdown sequence; and
switching, by the coolant control valve, a flowing path of a coolant through the first fluid passage or the second fluid passage under control of the controller,
wherein the coolant control valve is formed by integrating a first valve to switch a flowing path of the coolant flowing into a pump with a second valve to switch a flowing path of a coolant pumped by the pump.

11. The method of claim 10, wherein the performing of the shutdown sequence includes:
performing a first operation of setting a revolution per minute (RPM) of the pump to a preset value;
performing a second operation of controlling the valve opening amount of the coolant control valve to close a valve connected to the fuel cell stack and a radiator;
performing a third operation of setting an RPM of a second pump, which is configured to supply the coolant to a cooling fan and a power electronic part, to a preset minimum value;
performing a fourth operation of setting a relay of the COD heater to be turned on;
performing a fifth operation of setting an operating mode of the COD heater to a shutdown mode;
performing a sixth operation of deactivating an under voltage protection logic for the COD heater; and
performing a seventh operation for setting allowable power of the COD heater to a preset value.

12. The method of claim 11, wherein the coolant control valve includes:
a first port connected to the second fluid passage passing through the COD heater configured to allow the coolant to flow into the first port;
a second port connected to the first fluid passage passing through the fuel cell stack configured to allow the coolant to flow in the second port;
a third port configured to discharge the coolant, which inflows through the first port, through the second fluid passage connected to the pump through a fifth fluid passage configured to serve as a by-pass line of the radiator;
a fourth port configured to discharge the coolant, which inflows through the second port, through the first fluid passage connected to the pump through the fifth fluid passage; and
a fifth port configured to discharge the coolant which inflows through the second port, through a fourth fluid passage passing through the radiator.

13. The method of claim 12, wherein the performing of the second operation includes:
closing valves of the second port and the fourth port, which are connected to the first fluid passage, of the coolant control valve; and
opening valves of the first port and the third port, which are connected to the second fluid passage, of the coolant control valve.

14. The method of claim 12, wherein the performing of the second operation includes:
closing a valve of the fifth port, which is connected to the fourth fluid passage, of the coolant control valve to block the coolant from flowing into the radiator.

15. The method of claim 11, wherein the performing of the shutdown sequence includes:
iterating the first operation to the seventh operation of the shutdown sequence, until a monitoring voltage of the fuel cell stack is equal to or less than a reference voltage.

16. The method of claim 15, wherein the performing of the shutdown sequence includes:
performing an eighth operation for setting RPMs of the pump, the second pump, and the cooling fan to zero, when the monitoring voltage of the fuel cell stack is equal to or less than the reference voltage, during the first operation to the seventh operation of the shutdown sequence; and
performing a ninth operation for controlling the valve opening amount of the coolant control valve to open values connected to the fuel cell stack and the radiator, when the monitoring voltage of the fuel cell stack is equal to or less than the reference voltage, during the first operation to the seventh operation of the shutdown sequence.

17. The method of claim 10, further comprising:
performing the shutdown of the fuel cell stack, when the shutdown sequence is terminated.
